(19) United States
(12) Patent Application Publication
(10) Pub. No.: US 2007/0074608 A1
(43) Pub. Date: Apr. 5, 2007

(54) Gear control type multi-purpose wrench

(76) Inventor: Yi-Huang Mo, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/242,364

(22) Filed: Oct. 4, 2005

(51) Int. Cl. B25B 13/28

(52) U.S. Cl. 81/98; 81/111

(57) ABSTRACT

A wrench includes a handle having a gear and a pin hole and having a fixed jaw having a toothed face, a movable jaw having a first end provided with a gear and a pin hole and a second end provided with two toothed faces, two clamping plates rested on the handle and the movable jaw respectively, and two pins extended through the clamping plates respectively, and extended through the pin hole of the handle and the pin hole of the movable jaw respectively. Thus, the corresponding position of the gear of the handle and the gear of the movable jaw can be adjusted to regulate the size of the clamping space rapidly, so that the wrench is used to rotate workpieces of different sizes.

### BACKGROUND OF THE INVENTION

1. Field of the Invention

The present invention relates to a wrench, and more particularly to a gear control type multi-purpose wrench.

2. Description of the Related Art

A conventional wrench comprises a handle having a fixed jaw, and a movable jaw pivotally mounted on the fixed jaw of the handle by a bolt. The movable jaw has a bottom formed with a recess. Thus, the conventional wrench is used for operating a workpiece, such as a tubular member, a bolt or the like. However, the recess of the movable jaw allows passage of the fixed jaw so that the movable jaw has a thinner structure, thereby greatly decreasing the structural strength of the movable jaw. In addition, the movable jaw is pivotally mounted on the fixed jaw of the handle by a single bolt, so that the conventional wrench is used for operating a workpiece having a determined size, thereby limiting the versatility of the conventional wrench. Further, the workpiece easily slips from the wrench during operation, thereby causing inconvenience to the user. Further, the force applying point of the wrench is located at the central axis of the workpiece, so that the force applied by the user on the handle cannot be transmitted to the clamping space of the wrench, thereby decreasing the clamping effect of the wrench.

### SUMMARY OF THE INVENTION

In accordance with the present invention, there is provided a wrench for operating a workpiece, comprising a handle having a first end having an inwardly contracted arc-shaped hook structure and a second end having a flat shape, wherein the first end of the handle has a mediate portion provided with a gear and a pin hole and an arc-shaped hook portion formed with a fixed jaw having a toothed face; a movable jaw mounted on the handle and having a hook shape, wherein the movable jaw has a first end provided with a gear meshing with the gear of the handle and a pin hole corresponding to the pin hole of the handle and a second end provided with two opposite toothed faces corresponding to the toothed face of the fixed jaw of the handle; two clamping plates rested on the handle and the movable jaw respectively; and two pins extended through the two clamping plates respectively, and extended through the pin hole of the handle and the pin hole of the movable jaw respectively, so that the movable jaw is mounted on the handle.

The primary objective of the present invention is to provide a gear control type multi-purpose wrench.

Another objective of the present invention is to provide a wrench, wherein the clamping tension of the wrench is controlled by gears, and the clamping space is changed according to the size of the workpiece, so that the workpiece is clamped by the wrench rigidly and stably, thereby facilitating a user operating the wrench to rotate the workpiece.

A further objective of the present invention is to provide a wrench, wherein the movable jaw only has a single pin hole, thereby enhancing the structural strength of the wrench, simplifying the manufacturing process, and decreasing costs of fabrication.

A further objective of the present invention is to provide a wrench, wherein the corresponding position of the gear of the handle and the gear of the movable jaw can be adjusted to regulate the size of the clamping space rapidly, so that the wrench is used to rotate workpieces of different sizes.

A further objective of the present invention is to provide a wrench, wherein when the force applied on the handle is increased, the clamping space is shortened, so that the clamping force applied by the wrench on the workpiece is increased so as to clamp the workpiece efficiently to prevent the workpiece from slipping from the wrench, thereby facilitating a user operating the wrench to rotate the workpiece.

A further objective of the present invention is to provide a wrench, wherein the force applying point of the wrench is located adjacent to an inner side of the central axis of the workpiece to produce a larger clamping force, thereby enhancing stability of the wrench when rotating the workpiece.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench in accordance with the preferred embodiment of the present invention.

FIG. 2 is an exploded perspective view of the wrench as shown in FIG. 1.

FIG. 3 is a schematic plan operational view of the wrench as shown in FIG. 1 in use.

FIG. 4 is a schematic plan operational view of the wrench as shown in FIG. 1 in use.

FIG. 5 is a schematic plan operational view of the wrench as shown in FIG. 1 in use.

FIG. 6 is a schematic plan operational view of the wrench as shown in FIG. 1 in use.

### DETAILED DESCRIPTION OF THE INVENTION

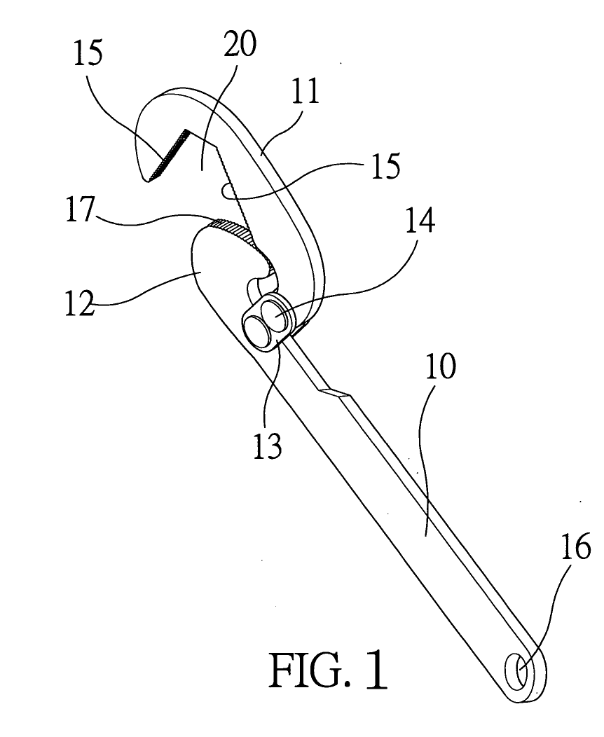

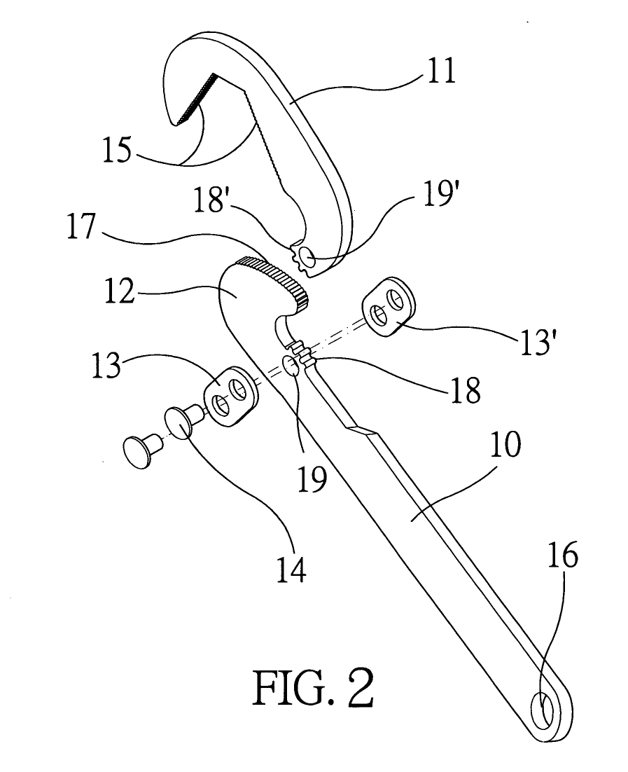

Referring to the drawings and initially to FIGS. 1-3, a wrench in accordance with the preferred embodiment of the present invention comprises a handle 10, and a movable jaw 11 mounted on the handle 10.

The handle 10 has a first end having an inwardly contracted arc-shaped hook structure and a second end formed with a hanging hole 16 for hanging the handle 10. The first end of the handle 10 has a mediate portion provided with a gear 18 and a pin hole 19 and an arc-shaped hook portion formed with a fixed jaw 12 having a toothed face 17.

The movable jaw 11 has a hook shape. The movable jaw 11 has a first end provided with a gear 18′ meshing with the gear 18 of the handle 10 and a pin hole 19′ corresponding to the pin hole 19 of the handle 10. The movable jaw 11 has a second end provided with two opposite toothed faces 15 corresponding to the toothed face 17 of the fixed jaw 12 of the handle 10. The toothed face 17 of the fixed jaw 12 of the handle 10 and the two opposite toothed faces 15 of the movable jaw 11 form a clamping space 20 therebetween.

The wrench further comprises two clamping plates 13 and 13′ rested on the handle 10 and the movable jaw 11 respectively, and two pins 14 extended through the two clamping plates 13 and 13′ respectively, and extended through the pin hole 19 of the handle 10 and the pin hole 19′ of the movable jaw 11 respectively, so that the movable jaw 11 is mounted on the handle 10.

Thus, the movable jaw 11 is mounted on the handle 10 by the two clamping plates 13 and 13′ and the two pins 14 so that the handle 10 and the movable jaw 11 have a determined movable allowance. In addition, the connecting state of the gear 18 of the handle 10 and the gear 18′ of the movable jaw 11 can be changed by the movable allowance, so that the connection of the handle 10 and the movable jaw 11 can be changed to shorten or expand the clamping space 20 so as to operate workpieces of different sizes. Thus, the clamping tension of the wrench is controlled by gears, and the clamping space 20 is changed according to the size of the workpiece, so that the workpiece is clamped by the wrench rigidly and stably, thereby facilitating a user operating the wrench to rotate the workpiece. In addition, the movable jaw 11 only has a single pin hole 19′, thereby enhancing the structural strength of the wrench, simplifying the manufacturing process, and decreasing costs of fabrication.

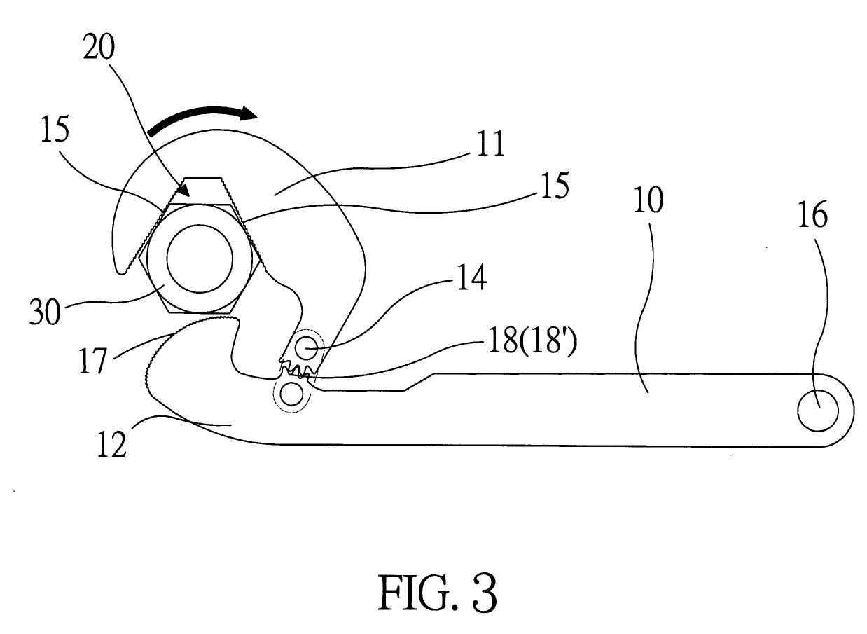

Referring to FIG. 3, a bolt 30 is mounted in the clamping space 20 formed by the toothed face 17 of the fixed jaw 12 of the handle 10 and the two opposite toothed faces 15 of the movable jaw 11. In such a manner, the toothed face 17 of the fixed jaw 12 of the handle 10 and the two opposite toothed faces 15 of the movable jaw 11 form a three-point engaging structure, so that the faces of the bolt 30 are clamped by the toothed face 17 of the fixed jaw 12 of the handle 10 and the two opposite toothed faces 15 of the movable jaw 11. When the force applied on the handle 10 is increased, the clamping space 20 is shortened, so that the clamping force applied by the wrench on the bolt 30 is increased so as to clamp the bolt 30 efficiently to prevent the bolt 30 from slipping from the wrench, thereby facilitating a user operating the wrench to rotate the bolt 30. In addition, the force applying point of the wrench is located adjacent to an inner side of the central axis of the bolt 30 to produce a larger clamping force, thereby enhancing stability of the wrench when rotating the bolt 30.

When the wrench is used to rotate bolts 30 of different sizes, the corresponding position of the gear 18 of the handle 10 and the gear 18′ of the movable jaw 11 can be adjusted to regulate the size of the clamping space 20, so that the wrench is used to rotate bolts 30 of different sizes.

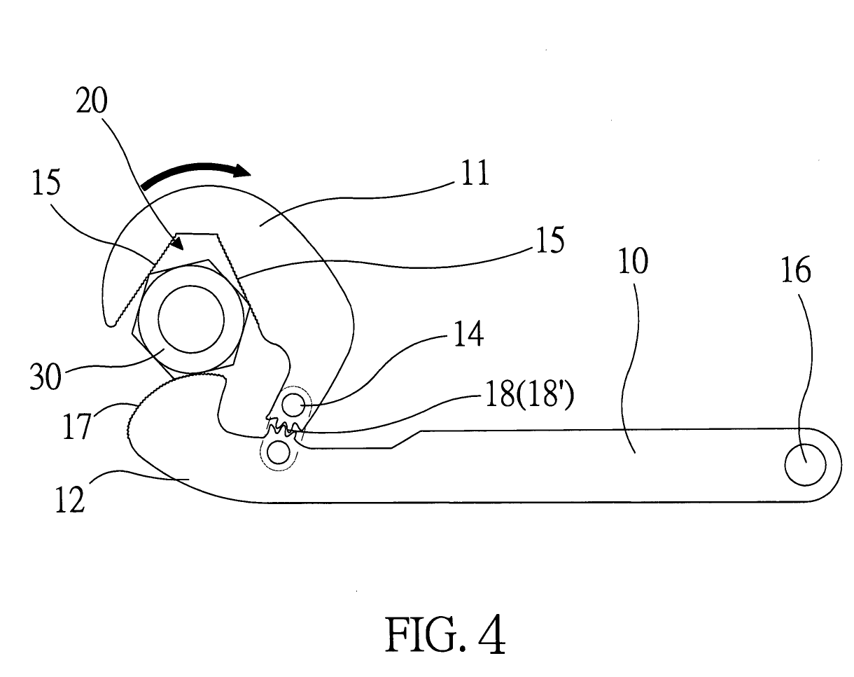

Referring to FIG. 4, the corners of the bolt 30 are clamped by the toothed face 17 of the fixed jaw 12 of the handle 10 and the two opposite toothed faces 15 of the movable jaw 11, so that the wrench clamp the bolt 30 in an irregular manner.

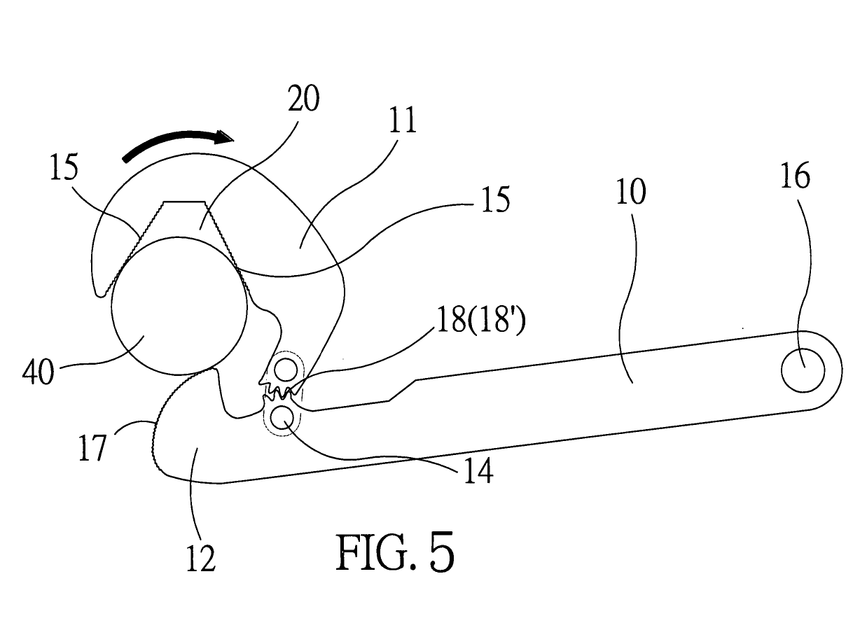

Referring to FIG. 5, a tubular member 40 is mounted in the clamping space 20 formed by the toothed face 17 of the fixed jaw 12 of the handle 10 and the two opposite toothed faces 15 of the movable jaw 11. In such a manner, the toothed face 17 of the fixed jaw 12 of the handle 10 and the two opposite toothed faces 15 of the movable jaw 11 form a three-point engaging structure, so that the outer surface of the tubular member 40 is clamped by the toothed face 17 of the fixed jaw 12 of the handle 10 and the two opposite toothed faces 15 of the movable jaw 11. When the force applied on the handle 10 is increased, the clamping space 20 is shortened, so that the clamping force applied by the wrench on the tubular member 40 is increased so as to clamp the tubular member 40 efficiently to prevent the tubular member 40 from slipping from the wrench, thereby facilitating a user operating the wrench to rotate the tubular member 40. In addition, the force applying point of the wrench is located adjacent to an inner side of the central axis of the tubular member 40 to produce a larger clamping force, thereby enhancing stability of the wrench when rotating the tubular member 40.

When the wrench is used to rotate tubular members 40 of different sizes, the corresponding position of the gear 18 of the handle 10 and the gear 18′ of the movable jaw 11 can be adjusted to regulate the size of the clamping space 20, so that the wrench is used to rotate tubular members 40 of different sizes.

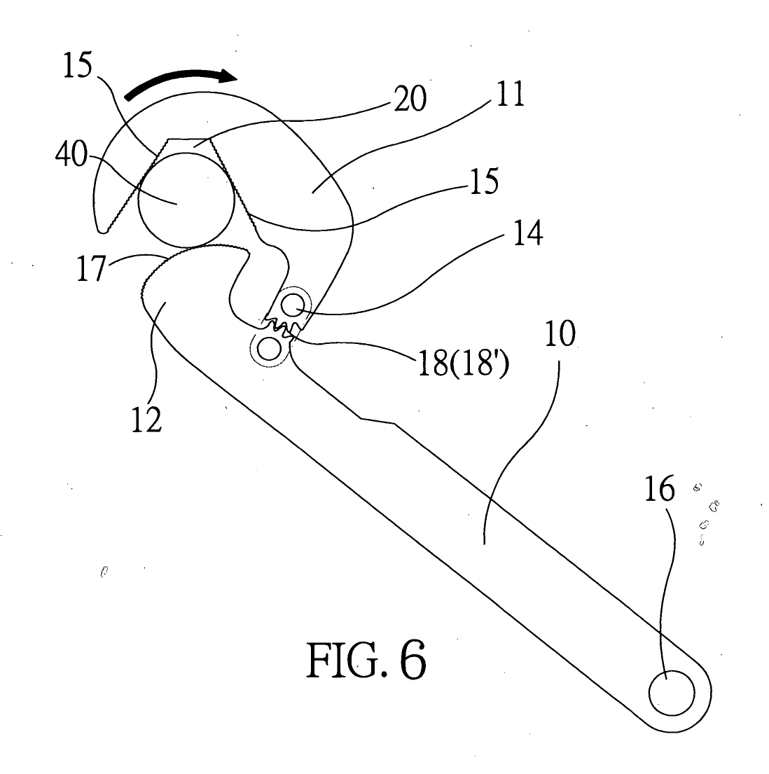

Referring to FIG. 6, the wrench is used to rotate a tubular member 40 having a smaller size than that shown in FIG. 5.

Accordingly, the clamping tension of the wrench is controlled by gears, and the clamping space is changed according to the size of the workpiece, so that the workpiece is clamped by the wrench rigidly and stably, thereby facilitating a user operating the wrench to rotate the workpiece. In addition, the movable jaw only has a single pin hole, thereby enhancing the structural strength of the wrench, simplifying the manufacturing process, and decreasing costs of fabrication. Further, the corresponding position of the gear of the handle and the gear of the movable jaw can be adjusted to regulate the size of the clamping space rapidly, so that the wrench is used to rotate workpieces of different sizes. Further, when the force applied on the handle is increased, the clamping space is shortened, so that the clamping force applied by the wrench on the workpiece is increased so as to clamp the workpiece efficiently to prevent the workpiece from slipping from the wrench, thereby facilitating a user operating the wrench to rotate the workpiece. Further, the force applying point of the wrench is located adjacent to an inner side of the central axis of the workpiece to produce a larger clamping force, thereby enhancing stability of the wrench when rotating the workpiece.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench for operating a workpiece, comprising:
a handle having a first end having an inwardly contracted arc-shaped hook structure and a second end having a flat shape, wherein the first end of the handle has a mediate portion provided with a gear and a pin hole and an arc-shaped hook portion formed with a fixed jaw having a toothed face;
a movable jaw mounted on the handle and having a hook shape, wherein the movable jaw has a first end provided with a gear meshing with the gear of the handle and a pin hole corresponding to the pin hole of the handle and a second end provided with two opposite toothed faces corresponding to the toothed face of the fixed jaw of the handle;
two clamping plates rested on the handle and the movable jaw respectively;
two pins extended through the two clamping plates respectively, and extended through the pin hole of the handle and the pin hole of the movable jaw respectively, so that the movable jaw is mounted on the handle.

2. The wrench in accordance with claim 1, wherein the toothed face of the fixed jaw of the handle and the two opposite toothed faces of the movable jaw form a clamping space therebetween, so that a force applying point of the wrench is located adjacent to an inner side of a central axis of a workpiece clamped in the clamping space to produce a relatively larger clamping force on the workpiece.

3. The wrench in accordance with claim 1, wherein a connecting state of the gear of the handle and the gear of the movable jaw is changed to change a corresponding position of the handle and the movable jaw to adjust a size of the clamping space.

4. The wrench in accordance with claim 1, wherein the workpiece clamped in the clamping space in an irregular manner.
